(19) United States
(12) Patent Application Publication
(10) Pub. No.: US 2010/0253787 A1
(43) Pub. Date: Oct. 7, 2010

(54) Method for Object Recognition and Communication of Associated Label and Other Information

(76) Inventor: Isaac Grant, La Jolla, CA (US)

Correspondence Address: DONN K. HARMS;PATENT & TRADEMARK LAW CENTER, SUITE 100, 12702 VIA CORTINA, DEL MAR, CA, 92014, US

(21) Appl. No.: 12/753,767

(22) Filed: Apr. 2, 2010

Related U.S. Application Data
(60) Provisional application No. 61/166,209, filed on Apr. 2, 2009.

(51) Int. Cl. H04N 5/225

(52) U.S. Cl. 348/207.1; 348/E05.024

(57) ABSTRACT

A method for providing information to a user concerning an object, which requires no user input to initiate. The method employs digital imaging equipment to capture a digital image of an object placed in a determined field of view. The digital image is communicated to a remote computer employing image recognition software to ascertain an identity of said object. Based on the identity and a relational database, information relating to said identity of said object is thereafter communicated to an electronic device proximate to the user which is capable of providing said information to said user in one or both of an audio broadcast and visual display.

### FIELD OF THE INVENTION

This application is a Continuation-in-Part and claims priority to, U.S. Provisional Application No. 61/166,209 filed 2 Apr. 2009 and which is incorporated in its entirety herein by reference.

The disclosed method relates to a service employing a network-engaged imaging device to communicate images to a server connected and data processor, and thereby initiate a response or communication to a user, based upon the recognized object or image captured and communicated by the imaging device. More particularly it relates to a method of operation of a service which based upon computerized image recognition and matching of the communicated image from a user, to an image or images accessible by an electronic memory, initiates one or a plurality of actions or communications which may be automatic or effected by user interaction with the object so recognized.

### BACKGROUND OF THE INVENTION

Package labeling for products and food has in recent years been increasingly regulated by governments. This is primarily to serve consumers and make them aware of the contents of a food product for instance, or the type or contents of non-food products.

Such labeling enables the consumer to ascertain value and contents as well as comparison shop with other products. It also allows the consumer to ascertain if their might be problems with the contents such as allergies for themselves or others.

However, such labeling is minimal on most products and generally very hard to read, as it is in small print. Further, the limited area available for it provides little space to give the consumer more information than is generally required by law.

Computers have allowed consumers to research products and materials, but only when close to their PC or laptop and with an internet connection. However it can be hard for people to research products due to the various distributors and manufacturers involved and the small print on the packaging and having to transpose that to a keyboard or web address, because transferring product information from the product to the computer conventionally requires the user to input a request manually or using a graphic interface. While computer systems and computer networks in the last decade have advanced in processing power and speed of data transmission on an exponential scale, such systems still require user input for even the simplest tasks. Despite the ever advancing nature of computer data processing and network hardware and transmission, some type of manual interface is generally required wherein a user input and/or action is required to actually generate most responsive actions by the computer.

As an example, with products sold in stores or used in homes, the user or buyer seeking additional information must either contact the manufacturer or must initiate interaction with a computer system. In stores, where UPC codes have become the conventional manner for marking products for both identification and price, customers wanting more information on the product are currently forced to try to read the minute text on the label, or speak with a sales associate in the store who may or may not know much about the product. For the customers who might be blind or visually handicapped, reading the label, or even ascertaining what a product is by touch, is not possible.

Since most stores now employ the UPC code for pricing of the product, if the shelf lacks a price display the buyer is left to guess or wait until reaching the check stand to find the cost. Some stores provide scanners in the aisles for users to scan the code and ascertain the price on a display. However, any additional information on the product itself is generally on the small print of the small label or package. Displaying a price on a screen while informational as to cost, is of little use to consumers seeking detailed product information about contents, construction or other product information. Further, a price display is of even less use to the blind or sight-impaired customers, since they cannot view the information displayed.

Larger items or items in catalogs may not bear any UPS code on their surface. For such items or catalog-displayed merchandise, the buyer is left to guess as to detailed product information and use or to seek the assistance of store personnel who may lack any knowledge about the product or its use and cost. Again, for the blind or sight-impaired, a product depiction is virtually worthless since they are unable to discern it.

Under the Fair Packaging and Labeling Act enacted in 1967, the Federal Trade Commission and the Food and Drug Administration require that all “consumer commodities” be labeled to disclose to customers and consumers the net contents, identity of commodity, and name and place of business of the product's manufacturer, packer, or distributor. This law authorizes additional regulations, where necessary, to prevent consumer deception (or to facilitate value comparisons) with respect to descriptions of ingredients, sack full of packages, use of “cents-off” or lower price labeling, or characterization of package sizes. Further, the Office of Weights and Measures of the National Institute of Standards and Technology, U.S. Department of Commerce, is authorized to promote, to the greatest practicable extent, uniformity in State and Federal regulation of the labeling of consumer commodities.

With the growth of product suppliers, products themselves, and the small area most packages provide for printing, providing the information required by the government is a hard task. Worse yet, even when properly printed on packaging, the amount of information given the consumer is the bare minimum required by law because of space limitations and it is generally in a typeface that is too small to read without magnification.

As a consequence, consumers are frequently left with insufficient information for comparative shopping or to ascertain potential problems with the contents such as allergies or use with other products with which there is an interaction which may be harmful, bleach and toilet cleaner as an example. Further, the blind or sight-impaired are left totally without even the most minimal information required of packaging and as a consequence at great disadvantage to sighted shoppers and possibly at a peril to themselves, should they have allergies to a food product or household product.

Lacking sufficient information in the store is an ever growing problem. Once the product or item is removed from the store and taken home, the consumer's lack of information worsens since exterior packaging can be removed. Ascertaining the contents of a bottle or container which may have been housed in a package, and which has been removed from that package, can be impossible. In the case of sight-impaired or blind consumers, even having labeled products at home does little good if they are unable to discern the labeling.

As such, there exists an unmet need for the provision of a method and device and related service, to provide the consumer with more information concerning items or images, easily and in a plurality of different media such as on a video display, and/or by audio, and/or in printed form from a printer, and/or in cases of the sight-impaired using a braille printer. Such media labeling and information, which will provide consumers in stores or at home or other venues, with information required by law about products, as well as information that would be helpful to the consumer beyond the packaging indicia.

In a retail environment such a method should require minimal action by the consumer and store staff to elicit an informational response for product information. The information provided should be provided on a video display, either static or portable, in a manner that not only provides the minimum information required by government regulation, but provides additional information to help the consumer utilize the product and/or compare it to other similar products.

Further, such a system should be adapted to be of additional help to the blind and sight-impaired consumers by providing in a sound reproduction, the information which is normally displayed on a display screen to other consumers. Further, the system should not only react to bar codes on the products, but also using video recognition of the product itself without the bar code so that packages with damaged codes can still be identified. Additionally, sight impaired or blind consumers, being unable to accurately place the bar code for scanner reading, would greatly benefit by such a system identifying the product itself from its size, shape, color, and indicia. Thereafter, a subsequent display of media labeling and/or oral presentation of the information on the labeling would provide sighted and unsighted consumers with product information needed for informed purchases and/or use and/or product comparison. The voiced or oral presentation to sight impaired consumers may be by wireless broadcast to a device worn or within earshot of the consumer.

Such a product media labeling and information system should minimize or virtually eliminate any textual input or graphic interface input requirement by the user, to thereby better operate in a retail setting which is not conducive to keyboards on each aisle or pointing devices to operate iconic interfaces. Such retail settings also host buyers who may not be computer literate and consequently would not be able to operate the system or might, as noted, be sight-impaired and unable to operate it.

Instead of conventional input devices to operate the system to provide information, such a method and system should employ a computerized interface which minimizes the knowledge or actions required of the user to elicit an action such as communication of information or initiating a sale. Such a system should allow for virtually any object itself, or rendering or depiction of the object or product, once communicated to a computer running software adapted to the task, to initiate a computer communication of information to the user, regarding the object or product and media labeling thereof. Further, in a retail or commercial setting, such a method should not only provide government required media labeling information, but should provide virtually unlimited product information from the manufacturer, along with coupons, competing product information, pricing, and other information desired by consumers.

Such a system should provide the aforementioned plurality of different media labeling and additional information in formats that multiple types of consumers may employ without the aid of store personnel to encourage widespread deployment and use. The elimination of the need to use a complicated input device will further this object immensely especially with sight-impaired users.

The availability of such media labeling will allow for an increase in information easily available and may allow for new regulations to unify the standard requirements of the new “media labeling” available to all consumers in a plurality of media. For example new regulations may require the manufacturer to host the labels at a government server, and in a certain electronic standard or format, and with certain contents before products are approved for sale to insure consumers have the various types of medial labeling easily available to make informed decisions.

Still further, such a method and system should also be adapted to work from the consumer's home or business to provide information after the purchase, when labeling may have been removed or when concerns or other informational desires are raised about a product. This would be especially helpful to the blind or sight-impaired who are at a disadvantage in a home setting where store personnel are not available and where they may even have trouble identifying what a product is. In the home setting as in the retail or business setting, the product identification can be ascertained without the need for a bar code scan, and instead the user may employ the product itself to ascertain the information to be provided. So identified by the remote computer and software, the provided information may be communicated to one or a plurality of users, in multiple streams such as video and audio, to thereby serve to communicate any consumer regardless of their sight ability or reading ability.

Still further, such a system should be adapted to employ customer-owned video and audio displays to broaden the deployment of the informational system by allowing retailers to purchase fewer kiosks or display stations and by allowing consumers to ascertain needed information without having to walk to another point in the store. Additionally, the system should be adaptable to actually purchase the product in a retail setting to encourage use and deployment by the retailer through cutting their costs of operation and increasing store efficiency.

Also, by using a consumer or user-owned electronic display and/or audio device, the user may also employ the device at home or outside the retail setting to ascertain media labeling and other product information based on the digital image of the product itself over a user-possessed audio and video reproduction device such as a cell phone, PDA, mp3 player, or other device having electronic communication capability and video and audio reproduction capability.

With respect to the above, before explaining at least one preferred embodiment of the method invention herein in detail or in general, it is to be understood that the method disclosed herein is not limited in its application to the details of construction and to the arrangement of the components or the steps in the method set forth in the following description or illustrated in the drawings. The various methods and combinations of methods and apparatus of the disclosed invention are capable of other embodiments, and of being practiced and carried out in various ways, all of which will be obvious to those skilled in the art once the information herein is reviewed. Also, it is to be understood that the phraseology and terminology employed herein are for the purpose of description and should not be regarded as limiting.

As such, those skilled in the art will appreciate that the conception upon which this disclosure is based, may readily be utilized as a basis for designing an object recognition and relational interface system and service to provide users with product media labeling and information through a video and/or audio communication thereof, and for carrying out the several purposes of the present disclosed device and method. It is important, therefore, that the embodiments, objects and claims herein, be regarded as including such equivalent methodology and operational components insofar as they do not depart from the spirit and scope of the present invention.

### SUMMARY OF THE INVENTION

The present invention contemplates a novel method for the provision of media labeling and product information and other action related to the product, which requires virtually no physically operated user input devices such as keyboards, mice or trackballs or barcode scanners. Minimizing the input device requirements, and UPC or other scanner requirement, allows for both computer-skilled and unskilled consumers to request and receive product media labeling and virtually unlimited information about a product by using the product itself as the means for initiation of provision of that information. Further, for sight-impaired users, the elimination of barcode and keyboard input provides a vast improvement of their ability to gain information about the identity of a product they can't see, or media labeling information and other information about all products, whether or not they themselves can identify them.

In complying with government regulations, the system will provide media labeling and additional product information about any product, which may be positioned within a viewing area of an imaging device operationally engaged with a computer, locally or over a network. As a consequence, instead of having to try and read limited amounts of information in fine print on a small package, the consumer is provided with a larger video display or audio reproduction of information from a computer about the product. The computer using software adapted to the task can identify the product using image recognition technology and software adapted to the task and mate that identification to stored information about the identified product. The information is then communicated to the user or consumer in the form of a media label and additional information that is depicted on a video display, and/or is provided as an audio version of the information which may be locally employed for the consumer to hear.

While the UPC code might work in some instances, such codes require laser scanners that most retail establishments are recalcitrant to place in the hands of consumers. Such scanners as noted also require a bit of dexterity and hand and eye coordination to operate and are thus out of the scope of use of the blind or sight-impaired. Consequently, the system herein, by using the item or object itself as the means to trigger the computer to provide audio and/or visually reproducible information, is safer and far easier to deploy both in retail venues as well as consumer homes and businesses. Further, at the retail or home level, the system can be adapted to employ a user-owned or possessed audio and video reproduction device to further encourage use and deployment.

In operation, the system and method herein employ one, or preferably a plurality, of video cameras or other electronic imaging means to generate a digital image of a field of view and any objects which may come into view or be situated in the field of view. The field of view may be any area which may be imaged by an electronic imaging device adapted to generate and communicate a digital image of part or all of that area, to a local or distant computer. This video imaging device and system herein may be employed in a retail setting at video stations, or using cameras operatively placed overhead and following customers, or by using a wireless communication within the store with user-owned devices capable of audio and video reproduction and optionally having an imaging device. At home or at an office the system can employ user-owned or operated imaging devices and computers to access the system and obtain needed media labeling and product information either using their computer for audio and video reproduction, or a capable portable device such as a cell phone, PDA or Mp3 player having WiFi or other wireless ability to communicate with a network. For instance, a cellphone with a camera and video display and audio production component wirelessly connected to a server, and having software adapted to the task, could easily capture a video rendition of an object, communicate it to a distant server for identification, and then operate to receive audio and video renditions of media labeling and other information about the object. This would work well in the home or retail establishment using WiFi or bluetooth or infrared communications to allow the portable device to communicate with the network. Or in the retail environment, audio/video devices might be provided to the customers on entry to the store or attached to shopping carts and thereby wirelessly provide the media labeling to the customer for objects identified by store or portable cameras. Portability of the reproduction in audio form would be especially helpful to sight-impaired users.

The captured area in the field of view, may be as small as a desktop, might be a portion of the shopping cart, or a stand positioned on a store aisle, or might be an entire room. The field of view so captured and communicated, may be in a business or a home or residence or public place, which is rendered viewable by video capture devices such as cameras placed in a static position or rotatable position, cameras at scanning stations or kiosks, or using the user's camera enabled cellphone or PDA or similar device in wireless communications with the server.

The images of products or product images, so captured and communicated by the system to a remote server and computer, will then be interpreted by software adapted to recognize images positioned within the field of view of a linked camera or other imaging device. Once so identified, by image recognition software or optionally bar code recognition, the computer initiates one or a plurality of information provision actions or communications to the user or customer based upon associated stored information about the identified object from a relational database of such information.

The service would best be provided by a large computer-oriented firm or provider adapted to the task, or by a large firm having network capabilities such as Google or Microsoft. Or, the service might be intra-company or home oriented where the imaging device communicates images of a field of view to a computer having software adapted to both recognize the object in the field of view, and to identify it and take actions from stored actions in the computer related to identified objects communicated to the computer from a video imaging device.

In use by a large and well financed and organized firm or firms having network communications, computers, and software adapted to the task, the system herein would allow individual objects, photos or renderings of those objects, or recognized logos, or other object identification means engaged to objects, to be recognized by the remote computer to which the image of an object is communicated.

For media labeling and government required information concerning products, such would be routinely provided to the service provider operating the system and relating that provided information stored images or data that can be matched to communicated digital images of an object from an imaging device. Thus, the consumer or customer is provided video and/or audio versions of that media labeling information once the product is placed in front of the imaging device and the system is somehow triggered to transmit the image captured and provide the information back to the user. Triggering can be something as simple as touching the object twice, pointing at it in the field of view, or pressing the “send” or other button on a cell phone or PDA if employed to capture the image and receive the audio and video response.

No display surface or designated frame of reference in the view of the video imaging device or camera view is needed to initiate an action relational to the object identified. The object itself, appearing anywhere in the field of view of the electronic imaging device, once the system is triggered and once the object is then recognized by software adapted to the task, will by its recognition, cause one or a plurality of individual, sequential, or related actions and communications by a computer back to the user in a store or home or other setting.

The store may in this fashion provide media labeling of products offered for sale in the store. In this fashion, a consumer wishing to read or to hear media label information about the product will place the product in the field of view of the imaging device they choose to employ. The imaging device, once triggered, will transmit the image of the object to a remote data processor where image recognition software will ascertain the identity of the item from its shape, dimensional characteristics, perimeter image, color, and/or other image recognition technology and methods.

Thereafter, media labeling information required by the government will be communicated from the computer back to the user and displayed on a video display proximate to the consumer and/or reproduced by an audio reproduction device proximate to the consumer. Additional information concerning the product may also be provided along with coupon information, sales information, related product information, and virtually any other information that the communicating computer may store in memory and relate to a visually identified product or object.

Further, coupons may be printed on a printer adjacent to the display for the identified item, or sent electronically for storage on a cellphone or PDA and later use. Coupons might also be sent for products related to the identified object to thereby encourage additional purchases by the user.

As noted, the video and/or audio presentation of the communicated information may be at a kiosk or other location in the store or home, or may be provided by the portable device wirelessly communicating with the remote computer which identifies the product or object. Employing the user's cell phone or PDA would be made possible by installing software adapted to operate on the portable device and interface with the remote computer communicating the media label and other information. If the portable device has an image capturing component such as a camera, it could also function to communicate object images.

In the case of a sight-impaired or blind user, the employment of a hand-held component would be especially helpful to provide an audio presentation of the media label without the user having to walk to a distant kiosk or stand for the information.

Consumers who register their profile with the store, or the service provider, and provide alternate means of communication for communication of media labeling and product information can also be provided with that information by email or voice mail or short messaging service. Further, in cases where the consumer registers payment information with the store related to their imaging device such as a cellphone, the consumer can actually provide an inventory of the products in their cart as they place them there by imaging each and triggering transmission of the image. Once finished, the consumer would send a signal from the phone or PDA to the service provider or to a communicating store server. The items identified by the user's phone or PDA transmitted images would be priced and totaled and a bill paid by the customer's pre registered means of payment such as a debit or credit card. This manner of operation would not only encourage use by vendors and retailers since it would save employee costs and be of minimal cost to implement, it would also provide the consumer with the ability to have the information about the identified products they place in their baskets stored on the service provider's computer for later provision of information about any product they imaged and placed in the cart.

In the case of a blind or sight-impaired user, by employing their own reader, camera-enabled phone or PDA, or other device, they may use it in a store setting or later at home to help identify products and objects. In the home, capturing an image of a known or unknown object and forwarding it to the service provider will cause media labeling and other product information to be returned to the user in audio format thereby providing sight-impaired users a means to identify virtually any object in the home or business using their cell phone or PDA or to also draft a running shopping list as products are used and that use communicated to the service provider.

Another aspect of the disclosed system, for instance, may be employed in a store where one or a plurality of cameras maintains the sales area of the store in view. Images of the sales area would be communicated to one or a plurality of computers. Software adapted to the task would watch customers as they place items in their basket and identify each item and the customer based on their appearance and image recognition software. Customers who pre-register a profile and cellphone or PDA identification number would be transmitted media labeling in audio and video format in real time as they shop using WiFi or Bluetooth or other wireless means for network communication. As the customer comes to the cashier, or some type of checkout station, the contents of the basket would be pre-identified as related to that specific customer, and would be itemized and communicated to the checkout station along with the bill due for the entire contents of the cart which was previously identified as placed therein using store cameras, or the user's hand-held phone or PDA or the like if camera-enabled.

Or, the customer may have the images of products they choose pre-stored in the computer such that no checkout station is required at all. Upon entering the field of view of the cameras in the store, the customer's face would be identified and related to pre-provided customer information regarding their phone, PDA, or other portable audio/video device and as to payment. As that individual customer walks through the store, and deposits items into their cart, those individual objects would be captured by store or user cameras and communicated to a store or other remote computer for identification. The identified items would be associated with that shopping trip that identified customer based on the original facial recognition and their pre provided profile. During the shopping trip, once a product is identified by an image transmitted, the associated media labeling would be streamed to their portable cellphone or PDA or the like.

As the customer leaves the store, their video image is recognized as leaving, and their bill would be forwarded to the pre-provided bill paying authority, such as a credit card, for full payment based on the items recognized by the service provider computer from transmitted images of the objects placed in the basket. Bar codes would not be required since the objects are identified using object recognition but could be captured to aid that recognition.

All the actions of identifying the customer, and itemizing their bill, would thus be ascertained by computers receiving video of the customer himself, and the images of the items as placed in the cart from store cameras or a user camera enabled device linked wirelessly. Triggering the capture and identification of items placed in the basket can be just the act of moving or touching the objects themselves and placing them in the defined basket area.

In another aspect of the method herein, video imaging devices may be monitoring an office or location for users entering and picking up brochures. For instance, the user who has chosen to have their face stored for image recognition might walk into a real estate office and pick up brochures on houses for sale. Based on the user's pre-provided contact information, and the communicated images of the individual brochures they picked up, electronic information may be sent to their email, or to their cellular phone. This might be in the form of PDF documents concerning the houses, or electronic maps communicated to their cellular phones or car mounted GPS units which will enable them to find the homes in question while driving.

The brochures may be recognized by their appearance from a pre-scanned image of the face of the brochure or a picture of the house or building on the brochure may be recognized based on a stored image of the actual house. The action by the computer to analyze the camera transmitted images may be initiated by the customer walking into the area imaged by the cameras or may be initiated by the computer ascertaining that logos or stickers engaged to the brochure surface have come into view. If the buyer or user is not recognized by the computer and software they might be asked, by a computer generated voice as they approach the exit or entrance, to identify a means for contact such as a cellular phone number or email address to which the computer may send subsequent information.

Computer image recognition software would use point recognition, logo or image recognition, scaling or pattern recognition, color recognition, or some other means, to take a communicated digital image from the remote cameras or imaging devices and compare it to stored images to ascertain a match. The subsequent action or actions the computer to communicated video and audio media labeling and information to the consumer or customer would be based solely on recognition of the object and an associated database of information matched to respective objects. The object, as noted, may be a three dimensional object such as a toaster, or might be a two-dimensional depiction of the object, such as a photo of a house printed on a brochure.

In another aspect of the invention, optionally the customer or other user may cause initial or secondary actions by the computer recognizing the object. This may be caused by gestural actions such as tapping the object by the hand of the user or by placement of the object into the confines of what the computer identifies as the shopping basket as it moves about the field of view of the imaging devices. Or, the user might touch the object and hold up their cell phone wherein the computer recognizing the object, the touch, the user's face, and the cell phone would provide information or a bill for the object to the user based on pre-provided user information associated with their stored image.

In yet another mode of the method and system herein, the provision of product information need not be limited to the store or venue of sale or the use of the consumer or customer's cellphone or PDA or the like. A webcam located in a business or home can also be enabled to capture object images and communicate them to the service provider over a network. Thereafter the user would be provided with media labeling and any other stored information about the object or brochure in front of the webcam. In this mode, the consumer will subscribe or sign up with the service wherein software will enable the webcam to communicate with a remote server. Thereafter, images of objects placed in the field of view of the webcam would be identified by the remote computer and elicit information transmissions back to the originating computer which may be displayed on the video display at the home or business.

In all modes of the method it is the recognition of the object itself, be it an item for purchase, a consumer or user, or a photo of the actual object on a brochure, which causes the computer to initiate one or a plurality of actions. No designated position for the object is required, just that it be in the field of view of the imaging devices and thereby recognizable to the computer using software adapted to the task and the system triggered to identify the object.

For instance in a hardware store, the user seeking more information, such as price and how to use a wrench, might hold the wrench up for a couple of seconds before replacing it on the shelf or placing it in their basket. Based on which place the wrench is deposited, the consumer would either be charged for the wrench on exit and provided with additional information, or if placed back on the shelf, the consumer would just get additional information sent to them.

Video recognition software, by analyzing and comparing frame/image sequence, identifying patterns and changing the sequence of images or by using any other image processing, combined with pattern algorithms, may employ an outline recognition of the object by ascertaining points around the perimeter to yield a digital fingerprint of the object or may employ color to ascertain what it is not, first, and then from the remainder of stored object images in memory, ascertain what the image matches which in this case is a wrench. Or pixels of the area the object occupies in the field of view may be employed to ascertain a digital shape or fingerprint for comparison to that of images stored of objects in memory. Or other means for software to ascertain a match between the object designated, and a digital image or images of the object pre-stored in a lookup memory or other database adapted to the task of comparing visual characteristics of the designated object to characteristics of images of the object in memory.

In the example at hand, once a match is determined between the wrench chosen and a digital image or images of the wrench stored in connected electronic memory, the software then will associate one or a plurality of predetermined actions to take, which have been associated with the stored image of the wrench.

In this example, if the user places the wrench back on a shelf, it would be ascertained they are not buying it and the user would not be billed but may be sent more information based on the recognition of the user by the software. However, if the user places the wrench in their basket, the computer identifies the basket and the placement of the wrench therein, and the software recognizes that placement of the object indicates a sale for which the user is charged on exit.

In another example, the user might be a child and the objects a plurality of plush toys resembling animals at a store or a school. The child need simply touch or move one of the toy animals for the computer to ascertain a choice by the child and initiate an action related to that choice and stored in memory. Thereafter, media labeling with required label information can be communicated in audio form and/or video form to a proximate audio-video display for the user to read or hear. Additional information may also be communicated.

In the case of a toy being chosen, if the child chooses a toy lion, the computer might also send a video program all about lions with video and/or audio to the video display adjacent to the child, or to the child's home computer based on computer recognition of the child and pre-provided contact information about the child. If in a store, and placed in a shopping cart, the computer may charge the parent's account for a purchase using pre-provided payment information and images relating the child's face or other recognized characteristics with the payment information of the parents. As can be seen, the only thing the child user or even an adult user need do is touch or move the object anywhere in the field of view of the imaging device such as the camera.

In yet another particularly preferred mode of the method herein, a service provider might provide a logo, or other indicia signification, as a means to initiate action by a computer. For example, to provide information to the user about that object related to the chosen and recognized indicia or to take an action based thereon.

For instance, at a delicatessen, using two dimensional images, plastic or real sandwiches might have a logo sticker placed upon them indicating the object which in this case is a recognized sandwich, is camera-enabling. The logo or symbol would be advertised or otherwise made known that if affixed to an object, that object will cause a computerized action if designated as chosen by a user. In this case, the user may choose a ham and cheese sandwich by touching it, and then they could touch a yellow dot on a sticker on the sandwich in view of the camera to order mustard, and a white dot to order mayonnaise on the chosen sandwich. The order would be entered and the sandwich custom produced based on recognition of the ham sandwich and the subsequent identification of user contact with other objects which in this case would be colored indicia.

In another mode of the system, a large provider such as Google, with an international presence, may provide and advertise a logo or symbol designator to potential consumers identifying that any object bearing the logo or symbol is camera-enabled. In such a system, the provider would issue an object designator image, which, when coming into the field of view of any camera communicating with a computer having software adapted to ascertain the presence of that object designator, would initiate a second action by the computer to ascertain the identity of the object itself, based on images sent from the camera of the field of view.

Once the object is identified, based on pre-stored actions related to the object bearing the issued logo or other indica, would occur relating to the identified object bearing the service provider's logo or symbol.

For instance, a user, receiving an order for a stapler from a supplier, would see that the object designator symbol was placed on the stapler such as on a sticker. In this case the object designator would be a logo on the sticker. The user, having been pre-educated to the fact by advertising or reading material, would recognize that the symbol, and would know that the symbol in combination with the image of the object initiates actions relating to the object based on user actions with the object itself. In a next step, using the internet or another wide area network, the user would go to a website for the manufacturer of the stapler adapted to receive images from the user's webcam. Once there, the user would hold the object in the field of view, and the computer receiving the transmitted electronic image of the object would recognize the symbol or logo, which would initiate the computer to then recognize the actual object itself. The computer would take an action or actions based on that recognition such as subsequently giving the user information about the identified object or a menu of choices related to the object from which the user may designate actions.

In the example at hand, once the remote computer ascertains the stapler is the object being held in the field of view, after recognizing the object designator on it, the computer might provide warranty or supply or other information about the object.

This object-designator service, can be employed on just about any object which can be placed in the viewing area of a camera which does or can communicate with a computer which would receive images from the viewing area. In this mode, the computer would first ascertain the existence of the object designator in the field of view, which in this case would be a logo sticker. Then, using images transmitted by the camera or other imaging device, the computer would ascertain the identity of the object itself from stored images thereof.

Subsequent to the second step, one or a plurality of actions would ensue initiated by the computer based upon recognition of the object and the logo or an object designator detected. Of course a plurality of object designators might be provided for one object which would elicit different responses based on the one chosen or communicated over the camera image to the computer.

The foregoing has outlined, rather broadly, the more pertinent and important features of the device and method herein providing a service which employs images of remote objects to initiate computer actions based on recognition of a digital communication of the object image. This is provided in order that the detailed description of the invention that follows may be better understood so that the present contribution to the art may be more fully appreciated. Additional features of the invention will be described hereinafter which form the subject of the claims of the invention. It should be appreciated by those skilled in the art that the conception and the disclosed specific embodiment may be readily utilized as a basis for modifying or designing other object oriented service provider methods for carrying out the same purposes of the present invention. It should also be realized by those skilled in the art that such equivalent constructions and methods do not depart from the spirit and scope of the invention as set forth in the appended claims.

In this respect, before explaining at least one embodiment of the invention in detail, it is to be understood that the invention is not limited in its application to the details of construction and to the arrangement of the steps or actions set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### THE OBJECTS OF THE INVENTION

It is therefore an object of the present invention to provide a service which employs a computer and electronic imaging interface to initiate actions by the computer related to or about the object identified.

It is a further object of the present invention to provide media labeling and other information concerning the product identified in a fashion that is easy to read and ascertain.

Yet another object of the invention is the provision of media labeling of products wherein minimum required information may be provided with additional information in video as well as audio communications.

It is another object of this invention to provide such a service that issues one or a plurality of object designators which may be combined with an object to initiate a response or action for the user based on the combination thereof.

It is another object of this invention to provide such an object oriented action provision service which does not require any designated area in the camera frame to initiate the action or actions subsequent to the viewing of the object.

An additional object of the invention is the provision of product information orally or in audio fashion, to users having impaired vision and unable to read either the product label or the video display.

The foregoing has outlined some of the more pertinent objects of the invention. These objects should be construed to be merely illustrative of some of the more prominent features and applications of the intended invention. Many other beneficial results can be attained by applying the disclosed method and device in a different manner or by modifying the invention within the scope of this disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### BRIEF DESCRIPTION OF THE DRAWINGS

The accompanying drawings, which are incorporated in and form a part of this specification, illustrate embodiments of the invention and together with the detailed description, serve to explain the principles of this invention.

FIG. 1 depicts a simple box diagram of the method herein which employs electronic transmission of objects or their depictions to initiate subsequent actions based on the transmitted image.

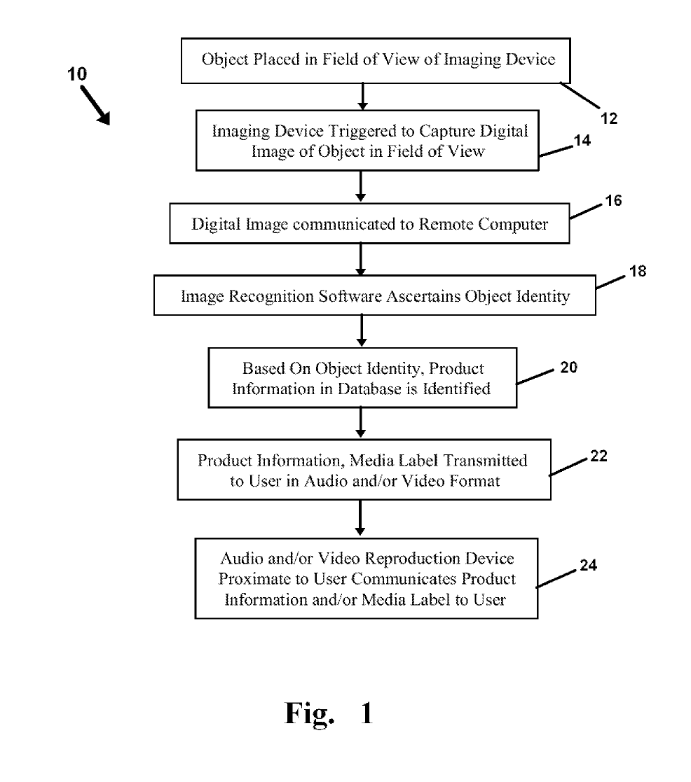

### DETAILED DESCRIPTION OF THE PREFERRED EMBODIMENTS

The system 10 herein, in operation, provides a means to react to a user action concerning an object, by employing the item or object itself, as the means to trigger or input a request to a computer running software adapted to the task, to provide audio and/or visually reproducible information, concerning or related to the object. The system 10 may be deployed in retail venues as well as consumer homes and businesses for this purpose and the system 10 can be adapted to employ a user-owned or possessed audio and/or video reproduction device, such as a cell phone, PDA, or MP3 player, as a means for display and broadcast of the information communicated, to further encourage use and deployment.

In operation, the system 10 and method herein, employs one or preferably a plurality of video cameras, or other electronic imaging devices, to capture and generate a digital image, of a field of view. In a first step 12, one or a plurality of objects is positioned into a field of view or be situated in the field of view. Responsive to the first step 12, in a second step 14, the imaging device or a connected computer or microprocessor running software adapted to the task, captures an image of the object. The field of view may be any defined area, which is imaged by an electronic imaging device adapted to generate and communicate a digital image of part or all of that defined area, to a local or distant computer.

Once the image is captured, or concurrently depending on how the imaging takes place, and whether the imaging device captures the image or the computer captures it using real time video from the imaging device, in a next sequential step 16, the image is communicated to a computer running software adapted to receive the image and process it.

The images of the object such as a product, so captured and communicated and communicated by the system to a remote server and computer, is then interpreted 18 by software adapted to recognize images positioned within the field of view of a linked camera or other imaging device. The software would operate to ascertain imaged data using one or a plurality of visual characteristics including but not limited to color, shape, size, language indica, and other visual and determined physical characteristics, and compare the determined imaged data to a relational database of such to identify it 20.

Once so identified, from the relational database and depending on who the user is and where they are located, information determined by the computer and software as related to the object, and appropriate to the user, is communicated 22 to the user's location in audio and/or video format. Data may also be communicated such as a PDF file concerning information about the identified object.

Once received at a position proximate the user's location, the information and/or data, is communicated 24 to the user who initiated the system 10. This communication may be by wireless transmission to a portable audio/visual electronic device, or to their cellphone or other means for receipt and reproduction of the information for the user. If the user has a system communicable cell phone or PDA player or a similar wireless device, the communication would be transmitted to the user's electronic device for communication to the user either visually or orally or both. If a data file is also sent it may be stored on the user's electronic device for use later.

Alternatively, the communication 24 for use by a user for a video and/or audio presentation of the communicated information may be at a kiosk or other location in the store or home, or may be provided by the portable device wirelessly communicating with the remote computer which identifies the product or object. Employing the user's cell phone or PDA would be made possible by installing software adapted to operate on the portable device and interface with the remote computer communicating the media label and other information. If the user's portable device has an image capturing component, such as a camera, it could also function to communicate object images 16.

Computer image recognition software would use point recognition, logo or image recognition, scaling or pattern recognition, color recognition, dimensional characteristics of the object, or some other means to employ the communicated digital image, from the remote cameras or imaging devices, and compare it to stored images and information, to ascertain a match. The video recognition software may also operate by analyzing and comparing frame/image sequence, identifying patterns and changing the sequence of images, or by using any other image processing, combined with pattern algorithms, may employ an outline recognition of the object by ascertaining points around the perimeter to yield a digital fingerprint of the object or may employ color to ascertain what it is not, first, and then from the remainder of stored object images in memory, ascertain what the image matches which in this case is a wrench. Or, pixels of the area the object occupies in the field of view may be employed to ascertain a digital shape or fingerprint for comparison to that of images stored of objects in memory. Or, other means for software as would occur to those skilled in the art to ascertain a match between the object and a digital image or images, or information about the object, may be employed and are anticipated within the scope of this application.

While all of the fundamental characteristics and features of the disclosed method of providing actions based on object images transmitted over a local or wide area network have been described herein, with reference to particular embodiments thereof, a latitude of modification, various changes and substitutions are intended in the foregoing disclosure and it will be apparent that in some instances, some features of the invention will be employed without the corresponding use of other features without departing from the scope of the invention as set forth. It should be understood that such substitutions, modifications, and variations may be made by those skilled in the art without departing from the spirit or scope of the invention. Consequently, all such modifications and variations are included within the scope of the invention as defined herein.

Further, the purpose of the herein disclosed abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

What is claimed is:

1. A method for providing information to a user concerning an object, comprising the steps of:
ascertaining a field of view for an electronic imaging device;
triggering said imaging device to capture a digital image of an object once placed in said field of view;
communicating said digital image to a computer running software adapted to receive said digital image;
employing image recognition software to ascertain an identity of said object; and
communicating information relating to said identity of said object to an electronic device capable of providing said information to said user in one or both of an audio broadcast and visual display.

2. The method of claim 1, additionally comprising the step of:
communicating a data file with said information relating to said identity of said object, to said electronic device.

3. The method of claim 1, additionally comprising the step of:
initiating electronic communication with a said electronic device in the possession of said user;
ascertaining a type of said electronic device in possession of said user, from a group consisting of a cell phone, a PDA, and a music player; and
communicating said information relating to said identity of said object in an electronic format determined to be employable by said type of electronic device.

4. The method of claim 2, additionally comprising the step of:
initiating electronic communication with a said electronic device in the possession of said user;
ascertaining a type of said electronic device in possession of said user, from a group consisting of a cell phone, a PDA, and a music player; and
communicating said information relating to said identity of said object in an electronic format determined to be employable by said type of electronic device.

5. The method of claim 1 additionally comprising the step of:
ascertaining if said user is sight impaired; and
if ascertained as sight impaired, communicating said information in an audio format.

6. The method of claim 2 additionally comprising the step of:
ascertaining if said user is sight impaired; and
if ascertained as sight impaired, communicating said information in an audio format.

7. The method of claim 3 additionally comprising the step of:
ascertaining if said user is sight impaired; and
if ascertained as sight impaired, communicating said information in an audio format.

8. The method of claim 4 additionally comprising the step of:
ascertaining if said user is sight impaired; and
if ascertained as sight impaired, communicating said information in an audio format.
